(19) United States
(12) Patent Application Publication
(10) Pub. No.: US 2014/0353316 A1
(43) Pub. Date: Dec. 4, 2014

(54) MULTI-PURPOSE STOCK POT

(71) Applicant: GUANGDONG ZHONGBAO KITCHENWARE CO., LTD., Guangdong (CN)

(72) Inventor: Nengchao LIN, Guangdong (CN)

(73) Assignee: GUANGDONG ZHONGBAO KITCHENWARE CO., LTD., Guangdong (CN)

(21) Appl. No.: 14/028,547

(22) Filed: Sep. 17, 2013

(30) Foreign Application Priority Data
May 31, 2013 (CN) 201310214899.2

(51) Int. Cl. A47J 36/10; A47J 36/08

(52) U.S. Cl. CPC A47J 36/10; A47J 36/08
USPC 220/573.1

(57) ABSTRACT

The multi-purpose stock pot includes a pot body and a lid; the lid has a lid knob, inside which a timing device is provided. The timing device has a magnetic plate, a magnet and a timer; the magnetic plate is fixed inside the lid knob; the timer is mounted onto the magnet; the magnet is attracted onto the magnetic plate to form a detachable connection. A temperature sensing opening is disposed on the lid and a sealing ring is disposed in the temperature sensing opening; a thermometer passes through the sealing ring and extends into an interior cavity of the pot body for temperature sensing. A strainer is rested on an upper periphery of the pot body. The functional features of the stock pot are configured practically. It is simple in structure and convenient to use. The timer has a reminder function to remind the user about the cooking time.

### BACKGROUND OF THE INVENTION

The present invention relates to cooking appliances and more specifically pertains to a multi-purpose stock pot.

Stock pots are basic necessities in our daily family lives. With the development of technology, there are more and more types of stock pots available in the market, and the cooking effects of the stock pots have also improved. Nevertheless, there are still some deficiencies found in the stock pots in the prior art. For instance, it is often difficult for a user to control the amount of food during cooking, thus resulting in wastage of food. In addition, the duration and degree of heating are difficult to control. This is especially true for cooking noodles where the amount of food, the amount of water and the duration and degree of heating are difficult to manage, thus resulting in wastage. Also, since it is not convenient for the user to drain the noodles after cooking is finished, the taste of the food is significantly affected. Therefore, a new product is anticipated to overcome the above deficiencies.

### BRIEF SUMMARY OF THE INVENTION

To overcome the shortcomings of the prior art, the present invention provides a multi-purpose stock pot which is simple in structure, convenient to use, and capable of providing food measuring and cooking reminder functions.

To attain this, the multi-purpose stock pot of the present invention comprises a pot body and a lid; the lid is disposed with a lid knob, inside which a timing device is provided.

The timing device comprises a magnetic plate, a magnet and a timer; the magnetic plate is fixed inside the lid knob; the timer is mounted onto the magnet; the magnet is attracted onto the magnetic plate to form a detachable connection.

Two U-shaped grooves are symmetrically disposed on the lid knob; the timer is disposed with U-shaped protrusions which correspond to the U-shaped grooves.

The lid knob is extended outward to form a thermometer mounting base; the thermometer mounting base has a through hole at its bottom end which overlaps with a temperature sensing opening on the lid for receiving a thermometer.

A sealing ring is provided inside the through hole and the temperature sensing opening.

Alternatively, a temperature sensing opening is disposed on the lid and a sealing ring is disposed in the temperature sensing opening; a thermometer passes through the sealing ring and extends into an interior cavity of the pot body for temperature sensing. Temperature can be measured more precisely. It is also more convenient for disassembly and assembly as sealing is done by using silica gel ring. The sealing ring can be safe and hygienic sealed silica gel ring.

A strainer is rested on an upper periphery of the pot body.

The pot body is provided with a rim at the upper periphery thereof for supporting an outer periphery of the strainer.

The strainer is in form of a disc, and a plurality of draining holes are provided on the disc. When draining, soup and sauce are drained from the draining holes.

The disc is provided with at least one measuring hole for measuring the amount of food such as noodles to be cooked.

A plurality of measuring holes with different inner diameters are provided on the disc; different inner diameters are for measuring different amount of food to be cooked.

The plurality of draining holes are provided on a first side of the disc; the plurality of measuring holes are provided at center and or on a second side of the disc.

The disc has an outer periphery; a handle is disposed on two sides of the outer periphery of the disc respectively.

Each of the handle comprises a fixed upper support, a return spring and a removable cover; the removable cover is removably placed onto the fixed upper support; the return spring is disposed in between the removable cover and the fixed upper support.

The fixed upper support is fixed onto a protrusion of the outer periphery by screws.

The handle is disposed on each of the two outer ends of an axis passing through the center of the disc.

In comparison with the prior art, the present invention has the following advantages: When cooking long noodles such as spaghetti, the measuring holes of the strainer can assist in controlling the amount of food, thus preventing wastage. The thermometer and the timer can help the user choose suitable cooking time at suitable temperatures, which helps making delicious dishes. The strainer is disposed with an automatic-return buckle handle which can be buckled onto a lower part of the rim of the pot body during draining. Hence, the strainer will not be disengaged easily and the user does not need to use both hands to operate the strainer. It can be used conveniently and can be easily detached for cleaning. The functional features of the stock pot are configured practically. It is simple in structure and convenient to use. The timer has a reminder function to remind the user about the cooking time. This can prevent wastage of energy resulted from over-cooking. The present invention has a certain market prospect and is therefore worth promoting.

### BRIEF DESCRIPTION OF THE DRAWINGS

FIG. 1 is a front view of the multi-purpose stock pot of the present invention;

FIG. 2 is a sectional view of the multi-purpose stock pot of the present invention in B-B direction;

FIG. 3 is a three-dimensional exploded view of the multi-purpose stock pot of the present invention;

FIG. 4 is a three-dimensional exploded view of the strainer of the multi-purpose stock pot of the present invention;

FIG. 5 is a partial three-dimensional exploded view of the multi-purpose stock pot of the present invention;

FIG. 6 is a partial three-dimensional view of the multi-purpose stock pot of the present invention;

FIG. 7 is a partial sectional view of the multi-purpose stock pot of the present invention;

FIG. 8 is a sectional view of the handle of the multi-purpose stock pot of the present invention, wherein the handle is in an opened position;

FIG. 9 is a sectional view of the handle of the multi-purpose stock pot of the present invention, wherein the handle is in a closed and locked position.

### DETAILED DESCRIPTION OF THE INVENTION

The present invention will be described in details with reference to the drawings and a specific embodiment below.

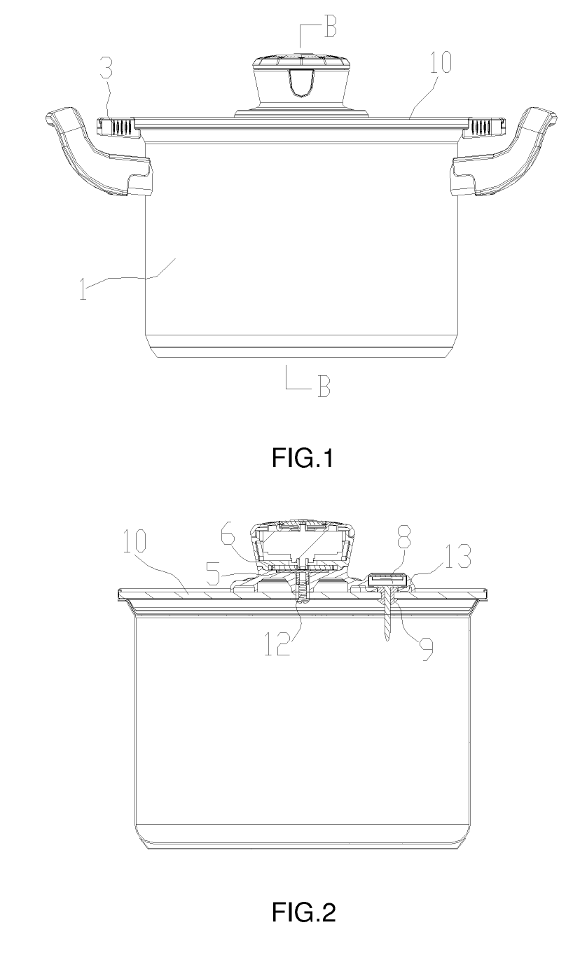

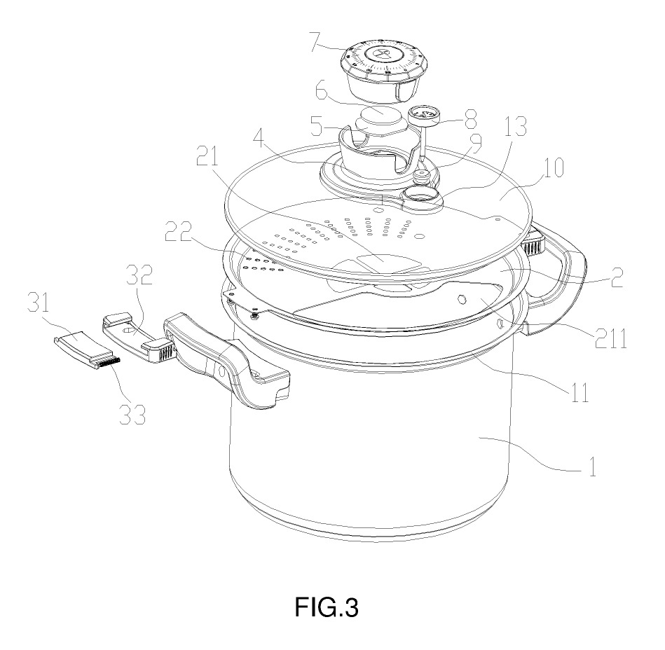

As shown in FIGS. 1-3, a multi-purpose stock pot comprises a pot body 1 and a lid 10. The lid 10 is disposed with a lid knob 4, inside which a timing device is provided. The timing device comprises a magnetic plate 5, a magnet 6 and a timer 7. The magnetic plate 5 is fixed inside the lid knob 4 by a screw 12, and the timer 7 is mounted onto the magnet 6. The magnet 6 is attracted onto the magnetic plate 5 to form a detachable connection. Two U-shaped grooves are symmetrically disposed on the lid knob 4. The timer is disposed with U-shaped protrusions which correspond to the U-shaped grooves. The U-shaped grooves engage with the U-shaped protrusions disposed on the timer 7 to ensure that when the lid knob 4 is rotated to start timing, as the timer 7 is engaged with the lid knob 4 by the engagement of the U-shaped grooves and the U-shaped protrusions to form one integral body, the rotating part of the timer 7 can be correspondingly rotated to start the timing function. The magnetic plate 5 mounted onto the lid knob 4 facilitates the timer 7 to be easily attracted and fixed thereon and easily removed therefrom. The magnet 6 is disposed at bottom of the timer 7 for attracting onto the magnetic plate 5 and thereby fixed onto the lid knob 4. The timer 7 can be easily removed for use and can also be attracted onto various magnetic household appliances for use in other cooking activities and occasions where timing is required. After the timer is removed, the lid can be washed in a machine such as a dish-washing machine. The lid knob 4 is extended outward to form a thermometer mounting base 13. The thermometer mounting base 13 has a through hole at its bottom end which overlaps with a temperature sensing opening on the lid which is used for receiving a thermometer 8. A sealing ring 9 is provided inside the through hole and the temperature sensing opening. As such, the lid knob 4 and the mounting base form an integral structure which is easy to assemble and aesthetically pleasing. A display of the thermometer 8 can be directly mounted in a groove of the mounting base for attaining better sealing effect.

The temperature sensing opening is disposed on the lid and a sealed ring 9 is disposed in the temperature sensing opening. The thermometer 8 passes through the sealed ring 9 and extends into an interior cavity of the pot body for temperature sensing and monitoring. Temperature can be measured more precisely. It is also more convenient for disassembly and assembly as sealing is done by using silica gel ring. The sealed ring 9 can be safe and hygienic sealed silica gel ring. The sealed silica gel ring 9 passes through the lid knob 4 and the lid 10. The thermometer 8 has a probe which passes through the sealed silica gel ring 9. Inner and outer surfaces of the sealed silica gel ring 9 are in close contact with the through hole of the thermometer of the lid knob 4 and a circular outer surface of the probe of the thermometer 8 respectively, thus attaining a sealing effect. The sealed silica gel ring 9 has a ring-shaped depression in a middle part thereof, wherein upper and lower surfaces of the depression are in contact with upper and lower surfaces of the lid 10 respectively, thus attaining an engagement effect. Since the silica gel ring 9 is elastic and flexible, it can be easily removed during disassembly.

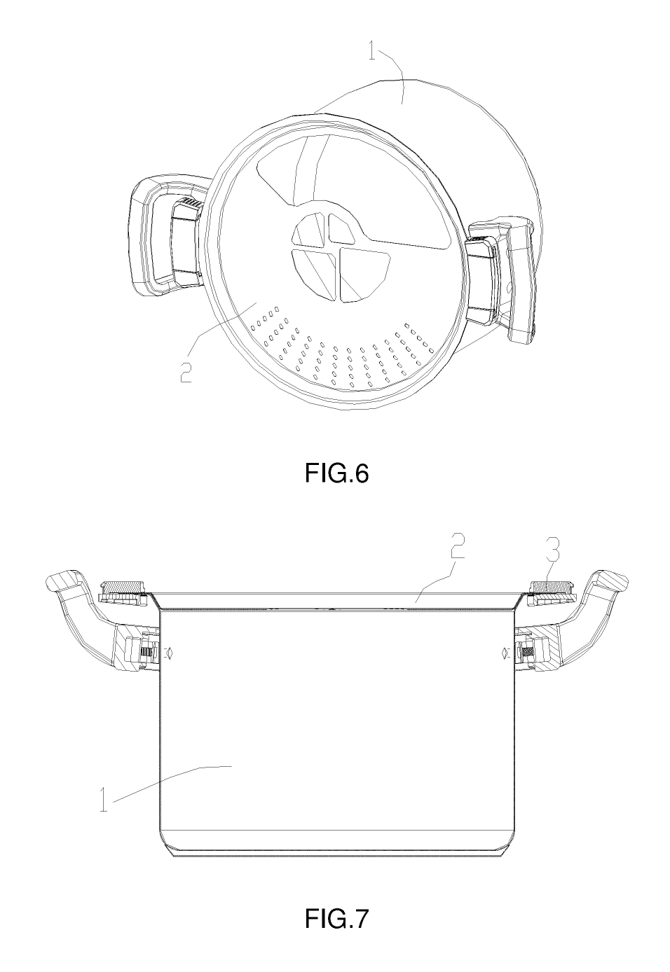

As shown in FIGS. 5-9, a strainer 2 is rested on an upper periphery of the pot body 1. The pot body 1 is provided with a rim 11 at the upper periphery thereof for supporting an outer periphery of the strainer.

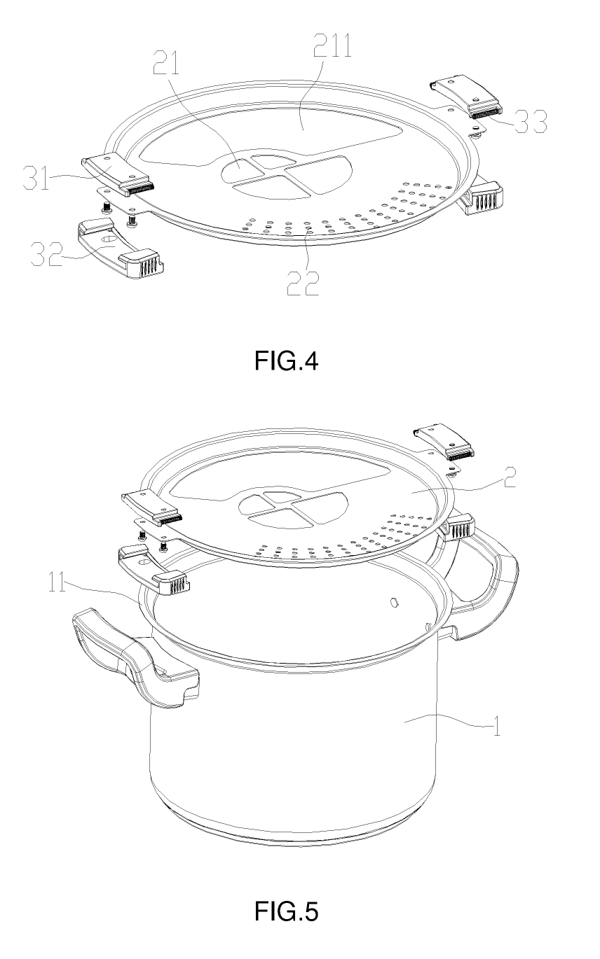

As shown in FIG. 4, the strainer 2 is in form of a disc. A plurality of draining holes 22 are provided on a first side of the disc. When draining, soup and sauce are drained from the draining holes 22. In this way, the taste of food can be effectively maintained. A plurality of measuring holes 21 with different inner diameters are provided at center and on a second side of the disc for facilitating the user to control the amount of food such as noodles (by measuring the amount of food according to the inner diameters of the measuring holes 21), thus preventing wastage due to cooking excess food. A biggest measuring hole 211 is provided on the second side of the disc which is used for placing the thermometer into the pot body 1. The outer periphery of the disc rests on the upper periphery of the pot body 1. A handle 3 is disposed on each of the two outer ends of an axis passing through the center of the disc. Each of the handle 3 comprises a fixed upper support 32, a return spring 33 and a removable cover 31. The fixed upper support 32 is fixed onto a protrusion of the outer periphery by screws. The removable cover 31 is removably placed onto the fixed upper support 32 to engage the outer periphery with the upper periphery of the pot body. The return spring 33 is disposed in between the removable cover 31 and the fixed upper support 32, and an outer end of the removable cover 31 is limited in position by the fixed upper support 32. The removable cover 31 is guided by the fixed upper support 32 and can therefore slide reciprocally by means of an external force or the return spring 33. The removable cover 31 has two outer sides, each of which has two ends and each of the two ends is provided with a protrusion. The protrusions are blocked by the fixed upper support 32 in the guiding direction so as to prevent the removable cover from disengaging from the fixed upper support 32.

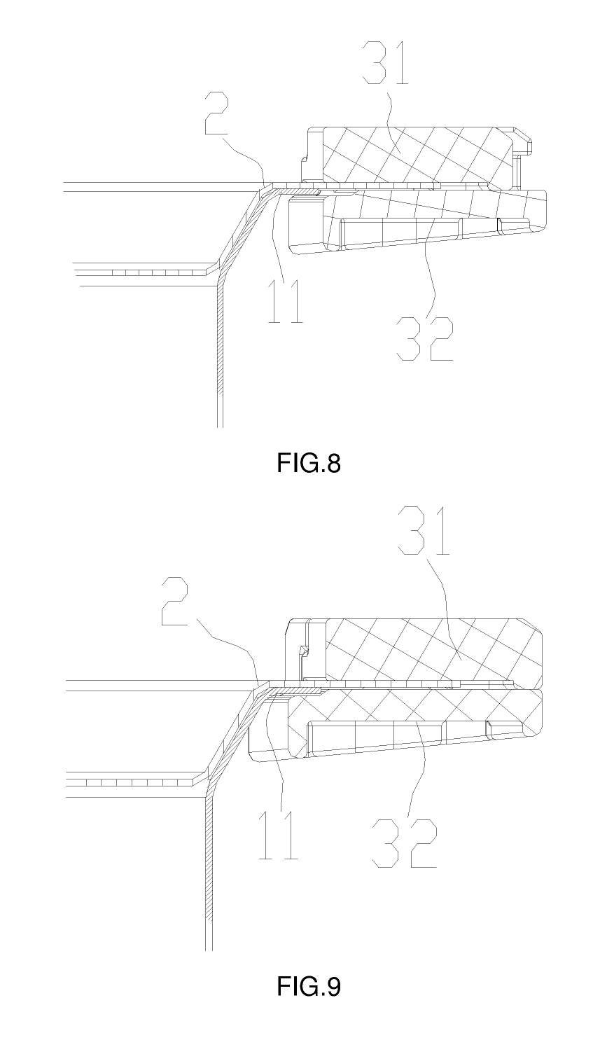

As shown in FIG. 8 and FIG. 9, when there is no external force, an inner end of the removable cover 31 is tightly pressed against the rim 11 of the pot body under the effect of the force of the return spring 33, such that the strainer 2 can be in close and tight contact with the upper periphery of the pot body 1. This prevents the user from the need of holding the strainer 2 by both hands when draining and hence danger such as scalding and inconvenience can be avoided. With the application of an external force, the inner end of the removable cover disengages from the rim of the pot body; at this moment, the strainer can be easily lifted up, so that the food can be easily served and the strainer can be easily cleaned.

The above description has described a preferred embodiment of the present invention in detail. It is understandable that any person skilled in the art could make various amendments and modifications based on the concept of the present invention without any inventive labor. Therefore, any technical proposals devised by means of logical analysis, deduction or limited experimentation by any person skilled in the art based on the concept of the present invention should fall within the scope of protection of the present invention as stated in the claims.

What is claimed is:

1. A multi-purpose stock pot which comprises a pot body and a lid, characterized in that the lid is disposed with a lid knob, inside which a timing device is provided.

2. The multi-purpose stock pot as in claim 1, characterized in that the timing device comprises a magnetic plate, a magnet and a timer; the magnetic plate is fixed inside the lid knob; the timer is mounted onto the magnet; the magnet is attracted onto the magnetic plate to form a detachable connection.

3. The multi-purpose stock pot as in claim 2, characterized in that two U-shaped grooves are symmetrically disposed on the lid knob; the timer is disposed with U-shaped protrusions which correspond to the U-shaped grooves.

4. The multi-purpose stock pot as in claim 1, characterized in that the lid knob is extended outward to form a thermometer mounting base; the thermometer mounting base has a through hole at its bottom end which overlaps with a temperature sensing opening on the lid; a sealing ring is provided inside the through hole and the temperature sensing opening.

5. The multi-purpose stock pot as in claim 1, characterized in that a temperature sensing opening is disposed on the lid and a sealing ring is disposed in the temperature sensing opening; a thermometer passes through the sealing ring and extends into an interior cavity of the pot body for temperature sensing.

6. The multi-purpose stock pot as in claim 4, characterized in that a strainer is rested on an upper periphery of the pot body.

7. The multi-purpose stock pot as in claim 6, characterized in that the pot body is provided with a rim at the upper periphery thereof for supporting an outer periphery of the strainer.

8. The multi-purpose stock pot as in claim 6, characterized in that the strainer is in form of a disc, and a plurality of draining holes are provided on the disc.

9. The multi-purpose stock pot as in claim 8, characterized in that the disc is provided with at least one measuring hole.

10. The multi-purpose stock pot as in claim 9, characterized in that a plurality of measuring holes with different inner diameters are provided on the disc; the plurality of draining holes are provided on a first side of the disc; the plurality of measuring holes are provided at center and or on a second side of the disc.

11. The multi-purpose stock pot as in claim 10, characterized in that the disc has an outer periphery; a handle is disposed on two sides of the outer periphery of the disc respectively.

12. The multi-purpose stock pot as in claim 10, characterized in that each of the handle comprises a fixed upper support, a return spring and a removable cover; the removable cover is removably placed onto the fixed upper support;
the return spring is disposed in between the removable cover and the fixed upper support.

13. The multi-purpose stock pot as in claim 2, characterized in that the lid knob is extended outward to form a thermometer mounting base; the thermometer mounting base has a through hole at its bottom end which overlaps with a temperature sensing opening on the lid; a sealing ring is provided inside the through hole and the temperature sensing opening.

14. The multi-purpose stock pot as in claim 2, characterized in that a temperature sensing opening is disposed on the lid and a sealing ring is disposed in the temperature sensing opening; a thermometer passes through the sealing ring and extends into an interior cavity of the pot body for temperature sensing.

15. The multi-purpose stock pot as in claim 3, characterized in that the lid knob is extended outward to form a thermometer mounting base; the thermometer mounting base has a through hole at its bottom end which overlaps with a temperature sensing opening on the lid; a sealing ring is provided inside the through hole and the temperature sensing opening.

16. The multi-purpose stock pot as in claim 3, characterized in that a temperature sensing opening is disposed on the lid and a sealing ring is disposed in the temperature sensing opening; a thermometer passes through the sealing ring and extends into an interior cavity of the pot body for temperature sensing.
